(19) United States
(12) Patent Application Publication
(10) Pub. No.: US 2025/0033170 A1
(43) Pub. Date: Jan. 30, 2025

(54) Stackable Locknut Socket

(71) Applicant: Robert Bosch GmbH, Stuttgart (DE)

(72) Inventors: Marcelo Moraes, Apple Valley, MN (US); Dennis Hanson, Medford, MN (US)

(21) Appl. No.: 18/384,226

(22) Filed: Oct. 26, 2023

Related U.S. Application Data
(60) Provisional application No. 63/529,158, filed on Jul. 27, 2023.

(51) Int. Cl. B25B 13/50; B25B 23/00

(52) U.S. Cl. CPC B25B 13/50; B25B 23/0035

(57) ABSTRACT

A locknut socket and locknut socket set having a stackable configuration. The locknut socket comprises a locknut shell configured to receive one or more locknut inserts, each of the shell and inserts configured to engage with a locknut of a different size. Locknut inserts can be placed or removed from the locknut shell in order to accommodate locknuts of different sizes. Torque from a lever is transferred from the shell to the stacked insert or inserts during operation via a driver sleeve that engages the lever to transfer torque from the lever to the locknut shell coupled with the driver sleeve.

### TECHNICAL FIELD

This disclosure relates to specialty hand tools for automotive service.

### BACKGROUND

Locknut sockets are used in interchangeable sets with a ratchet lever to adjust the tightness of automotive locknuts during service. Currently, large sets of locknut sockets are utilized to accommodate a wide variety of sizes and shapes of locknuts used in different purposes within an automobile, or for accommodating different vehicle makes or models. Large sets of locknuts require a large amount of space for storage in a service area and utilize a large quantity of material to manufacture.

What is desired is a locknut sockets that can be manufactured utilizing fewer materials do reduce manufacturing costs and time, and also provides a more compact storage solution for a user, without reducing the compatible range of locknut sizes available to the user.

### SUMMARY

One aspect of this disclosure is directed to a locknut socket comprising a locknut shell, a bar affixed to the locknut shell, a driver sleeve coupled to the bar, a first locknut insert, and a second locknut insert. The bar is configured to transfer torque from the driver sleeve to the locknut shell. The locknut shell has an inner surface configured to engage with a locknut of a first size. The first locknut insert has an inner surface configured to engage with a locknut of a second size, the second size being smaller than the first size. The second locknut insert has an inner surface configured to engage with a locknut of a third size, the third size being smaller than the second size. The first locknut insert has an outer surface comprising a catch configured to engage with the inner surface of the locknut shell and transfer torque from the locknut shell to the first locknut insert. The second lockout insert has an outer surface comprising a catch configured to engage with the inner surface of the first locknut insert and transfer torque from the first locknut insert to the second locknut insert.

Another aspect of this disclosure is directed to a locknut socket comprising a locknut shell, a bar affixed to the locknut shell, a driver sleeve coupled to the bar, and a locknut insert. The bar is configured to transfer torque from the driver sleeve to the locknut shell. The locknut shell has an inner surface configured to engage with a locknut of a first size. The first locknut insert has an inner surface configured to engage with a locknut of a second size, the second size being smaller than the first size. The second locknut insert has an inner surface configured to engage with a locknut of a third size, the third size being smaller than the second size. The first locknut insert has an outer surface comprising a catch configured to engage with the inner surface of the locknut shell and transfer torque from the locknut shell to the first locknut insert. The second locknut insert has an outer surface comprising a catch configured to engage with the inner surface of the first locknut insert and transfer torque from the first locknut insert to the second locknut insert.

A further aspect of this disclosure is directed to a locknut socket set comprising a first locknut shell, a second locknut shell, a first locknut insert, a second locknut insert, and a driver sleeve. The first locknut shell has a first shell inner surface configured to engage with a locknut of a first size and a bar affixed to the first shell inner surface configured to transfer torque to the first locknut shell. The second locknut shell has a second shell inner surface configured to engage with a locknut of a second size and a bar affixed to the second shell inner surface configured to transfer torque to the second locknut shell. The first locknut insert has an inner surface configured to engage with a locknut of a third size, the third size being smaller than the first size. The second locknut insert has an inner surface configured to engage with a locknut of a fourth size, the fourth size being smaller than the second size. The first locknut insert has an outer surface with a catch configured to engage with inner surface of the first locknut shell such that the catch transfers torque from the first locknut shell to the first locknut insert when the catch is engaged. The second locknut insert has an outer surface with a catch configured to engage with the inner surface of the second locknut shell such that that catch transfers torque from the second locknut shell to the second locknut insert when the catch is engaged. The locknut socket set further comprises a driver sleeve configured to engage with each of the bar of the first locknut shell and the bar of the second locknut shell. The driver sleeve is configured to transfer torque from a compatible ratchet lever to a respective bar with which it is engaged.

The above aspects of this disclosure and other aspects will be explained in greater detail below with reference to the attached drawings.

### BRIEF DESCRIPTION OF THE DRAWINGS

FIG. 1 is an exploded view of a stackable locknut socket viewed from a first angle.

FIG. 2 is an exploded view of the stackable locknut socket of FIG. 1 from a second angle.

FIG. 3 is an alternative view of the stackable locknut socket of FIG. 1.

FIG. 4 is an alternative view of the stackable locknut socket of FIG. 1.

FIG. 5 is an exploded view of a set of stackable locknut sockets.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

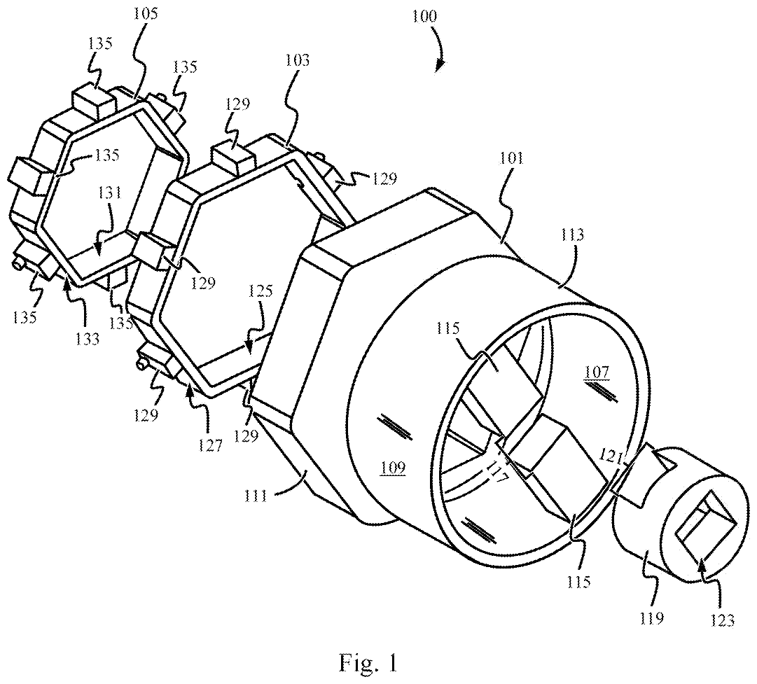

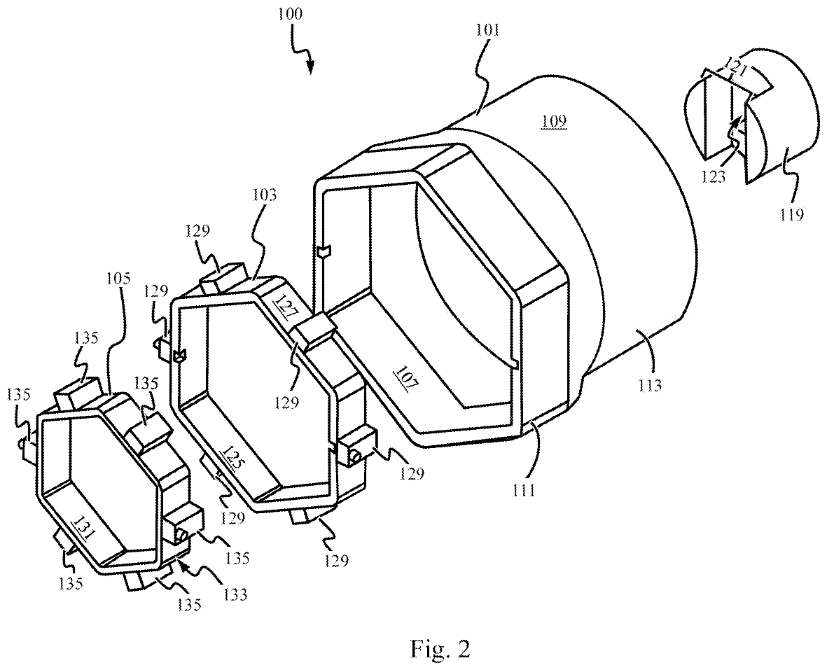

FIG. 1 and FIG. 2 each present an exploded view of a locknut socket 100 according to an embodiment of the invention disclosed herein. FIG. 1 presents locknut socket 100 from a first angle, and FIG. 2 presents locknut socket 100 from a second angle. Locknut socket 100 comprises a locknut shell 101, a first locknut insert 103 and a second locknut insert 105. Locknut shell 101 comprises both a socket portion 111 and a neck portion 113. Locknut shell 101 additionally comprises a shell inner surface 107 and a shell outer surface 109.

The shell inner surface 107 is configured to interact with other functional components. In the depicted embodiment, the shell inner surface 107 of the socket portion 111 is configured to engage with a lockout of a particular geometry. During operation, the shell inner surface 107 within the socket portion 111 engages with a locknut of appropriate size to transfer torque to the locknut. In the depicted embodiment, the socket portion 111 has a polygonal cross-section with six sides, thus permitting the shell inner surface 107 to engage with a 6-point locknut of the appropriate size. Other embodiments may comprise a different cross-section to yield different compatibilities. In some embodiments, the cross-section of the socket portion 111 of locknut shell 101 may have a different number of sides, such as an eight-sided polygon suitable to engage with an 8-point lockout of appropriate size. Other embodiments may comprise different configurations suitable for other locknuts having other dimensions, such as a square, polygon, circle, ellipse, or any other fastener style recognized by one of ordinary skill without deviating from the teachings disclosed herein.

The shell inner surface 107 within the neck portion 113 further comprises at least one bar 115 affixed thereto. In the depicted embodiment, two bars 115 are affixed at opposite points in line with a diameter of the cross-section of neck portion 113 and are arranged with a gap 117 between them. This configuration is advantageous because the two bars 115 are suitable for improved transfer of torque from bars 115 to the rest of locknut shell 101. In the depicted embodiment, torque may be achieved via a driver sleeve 119, which engages with bars 115 via a bar receiver 119. In the depicted embodiment, bar receiver 121 comprises a channel of driver sleeve 113 which engages bars 115 during operation of locknut socket 101 to transfer torque from and external level (not shown) to the driver sleeve 119 and subsequently to bars 115. Other embodiments may comprise other configurations, such as a single bar extending along a line running through the center point of the cross section of neck portion 113. In the depicted embodiment, each of bars 115 are welded to shell inner surface 107, but other embodiments may utilize other modes to affix one or more bars 115 to the shell inner surface 107 without deviating from the teachings disclosed herein.

Driver sleeve 119 additionally comprises a receptacle 123 configured to engage with the bit of a lever. In the depicted embodiment, receptacle 123 is configured as a bit receiver 123 suitable to accept a standard square bit from a lever such as a ratchet lever arm or torque multiplier (not shown) but other embodiments may comprise a driver sleeve configuration compatible with other or additional bit types without deviating from the teachings disclosed herein.

In the depicted embodiment, neck portion 113 has a circular cross section, but other embodiments may comprise other geometries without deviating from the teachings disclosed herein.

First locknut insert 103 comprises a first insert inner surface 125 and a first insert outer surface 127. First insert inner surface 125 is configured to engage with a locknut of a second size that is smaller the size of the locknut compatible with shell inner surface 107. The cross-section of first locknut insert 103 is a polygon of similar geometry to the cross section of the socket portion 111 of the locknut shell 101, but having a smaller total area. This geometric similarity advantageously permits first locknut insert 103 to be placed (or “stacked”) inside locknut shell 101 for storage or during application of torque. When first lockout insert 103 is positioned inside the socket portion 111 of locknut shell 101, torque can be transferred from locknut shell 101 to first locknut insert 103. This torque transfer enables a further torque transfer from first locknut insert 103 to an engaged locknut. First insert outer surface 127 comprises at number of first catches 129 to enhance the transfer of torque. In the depicted embodiment, catches 129 comprise edge catches and point catches, but other embodiments may comprise different configurations having different or singular types of catches without deviating from the teachings disclosed herein. Catches 129 advantageously engage with the shell inner surface 107 to optimize the transfer or torque during operation of the locknut socket.

First locknut insert 103 can advantageously be removed from locknut shell 101 in order to utilize the locknut socket with a locknut having a geometry matching that of locknut shell 101, and replaced when a user wishes to engage with a locknut having a geometry matching that of first locknut insert 103.

Second locknut insert 105 comprises a second insert inner surface 131 and a second insert outer surface 133. Second insert inner surface 131 is configured to engage with a lockout of a third size that is smaller the size of the locknut compatible with first locknut insert 103. The cross-section of second locknut insert 105 is a polygon of similar geometry to the cross section of first locknut insert 103, but having a smaller total area. This geometric similarity advantageously permits second locknut insert 105 to be placed (or “stacked”) inside first locknut insert 103 for storage or during application of torque. When second locknut insert 105 is positioned inside the first locknut insert 103, torque can be transferred from first locknut insert 103 to second locknut insert 105. This torque transfer enables a further torque transfer from second locknut insert 105 to an engaged locknut. Second insert outer surface 135 comprises at number of second catches 135 to enhance the transfer of torque. In the depicted embodiment, catches 135 comprise edge catches and point catches, but other embodiments may comprise different configurations having different or singular types of catches without deviating from the teachings disclosed herein. Catches 135 advantageously engage with the first insert inner surface 125 to optimize the transfer or torque during operation of the locknut socket.

Second locknut insert 105 can advantageously be removed from first locknut insert 103 in order to utilize the locknut socket with a locknut having a geometry matching that of first locknut insert 103, and replaced when a user wishes to engage with a locknut having a geometry matching that of second locknut insert 105.

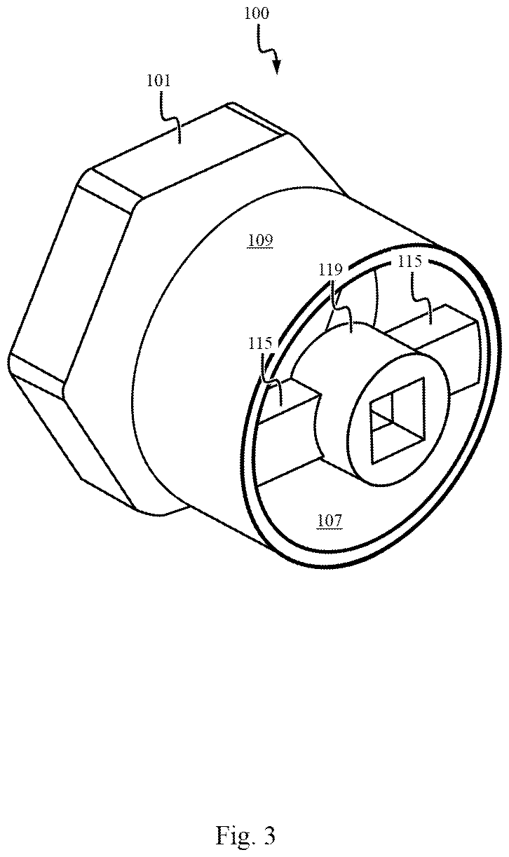

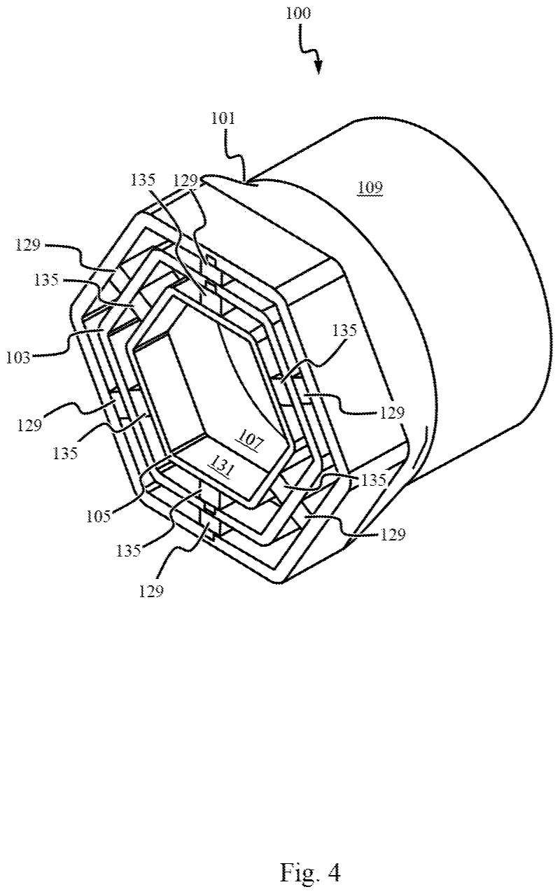

FIG. 3 and FIG. 4 each show locknut 100 in stacked configuration from different angles. In this stacked configuration, locknut 100 is suitable to engage with a locknut having a geometry matching that of second locknut insert 105. If a user wishes to engage a different locknut, second lockout insert 105 could be removed to permit a user to engage with a locknut having a geometry matching that of first locknut insert 103. Alternatively, both second locknut insert 105 and first locknut insert 103 could be removed to engage with a locknut having a geometry matching socket portion 111 of locknut shell 101. Other embodiments may comprise a different number or configuration of locknut inserts without deviating from the teachings disclosed herein.

By way of example, and not limitation, some embodiments may comprise as many as 5 locknut inserts of cascading sizes without deviating from the teachings disclosed herein. In the depicted embodiment, the cross-sections of each of locknut shell 101 and each locknut insert comprise regular six-sided polygons suitable to engage with 6-point locknuts of varying sizes, but other embodiments may comprise other configurations without deviating from the teachings disclosed herein. By way of example, and not limitation, some embodiments may comprise cross-sections of a regular eight-sided polygon suitable to engage with 8-point locknuts of varying sizes without deviating from the teachings disclosed herein. In some embodiments, the cross-sectional configuration of any particular locknut shell or locknut insert may be a distinct shape from one or more of the other locknut shell or locknut insert in a set of locknut sockets without deviating from the teachings disclosed herein.

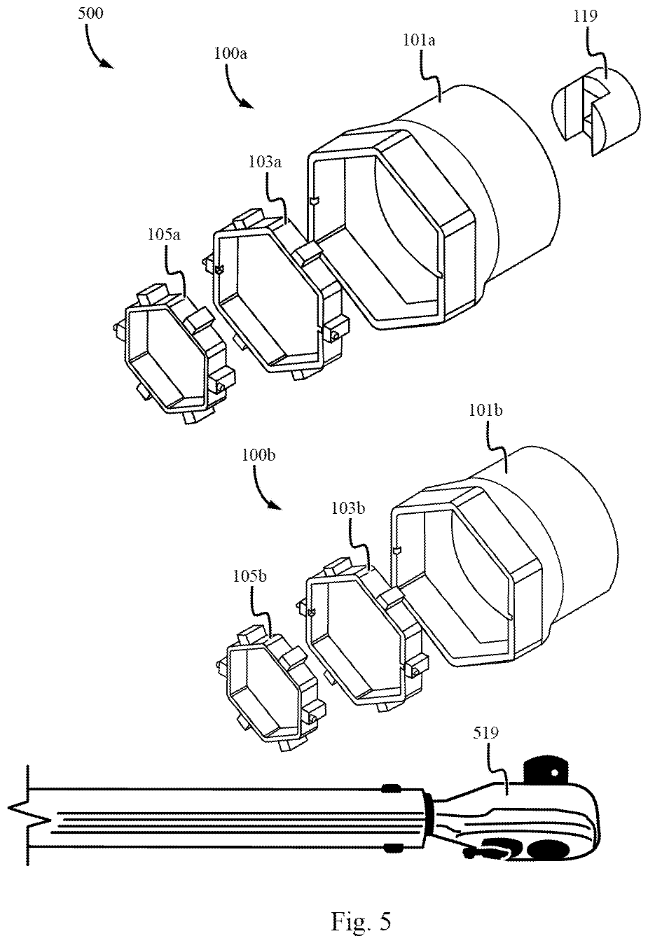

FIG. 5 is an illustration of a simple locknut socket set 500 comprised of two similar lockout sockets 100 according one embodiment of the invention disclosed herein. In this embodiment, locknut socket 100a and locknut socket 100b comprise similar geometries, but each component thereof is configured to engage with a locknut of a different size. In the depicted set, only a single driver sleeve 119 is required to utilize the complete set, which is compatible with a supplied lever 519. In the depicted embodiment, the supplied lever comprises a ratchet lever 519 having a square bit, but other embodiments may comprise different configurations without deviating from the teachings disclosed herein. In some embodiments, different locknut sockets 100 may comprise different or additional geometries without deviating from the teachings disclosed herein. By way of example, and not limitation, other embodiments may comprise eight-sided cross-sections to engage with 8-point locknuts without deviating from the teachings disclosed herein. In some such embodiments, some of locknut sockets 100 may be configured to engage 6-point locknuts and some of locknut sockets 100 may be configured to engage 8-point locknuts without deviating from the teachings disclosed herein.

Each of locknut sockets 100 are understood to comprise a locknut shell 101 and one or more associated compatible locknut inserts, such as a first locknut insert 103 or a second locknut insert 105. In the depicted embodiment, some of locknut inserts 103 or 105 may be broadly compatible with a plurality of locknut shells 101 without deviating from the teachings disclosed herein. By way of example, and not limitation, first locknut insert 103a may be functionally compatible for stacking within locknut shell 101b and functionally compatible to be stacked with second locknut insert 105b without deviating from the teachings disclosed herein. In such cross-compatible embodiments, it is expected that the respective locknut inserts involved are sufficiently close in size and geometry to accommodate this cross-compatibility, and that some locknut shells 101 or locknut inserts 103 or 105 may not be cross-compatible with any other components of the locknut socket even if other such components have cross-compatibility. In some such embodiments, cross-compatibility may not be limited to components having similar cross-sectional geometry without deviating from the teachings disclosed herein.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A locknut socket comprising:
a locknut shell having a shell inner surface, the shell inner surface configured to engage with a lockout of a first size;
a bar affixed to the shell inner surface;
a driver sleeve coupled to the bar, the driver sleeve having a receptacle configured to engage with a lever;
a first locknut insert having a first insert inner surface and a first insert outer surface, the first insert inner surface configured to engage with a locknut of a second size smaller than the first size; and
a second locknut insert having a second insert inner surface and a second insert outer surface, the second insert inner surface configured to engage with a locknut of a third size smaller than the second size,
wherein
the bar is configured to transfer torque to the locknut shell,
the first insert outer surface comprises a first catch that engages with the shell inner surface under torque, and
the second insert outer surface comprises a second catch that engages with the first insert inner surface under torque.

2. The locknut socket of claim 1, wherein the bar is welded to the shell inner surface.

3. The locknut socket of claim 1, wherein each of the shell inner surface, the first insert inner surface, and the second insert inner surface comprises a polygonal cross-sectional shape having six sides or eight sides.

4. The locknut socket of claim 1, further comprising a third locknut insert having a third insert inner surface and a third insert outer surface, the third insert inner surface configured to engage with a locknut of a fourth size smaller than the third size, and the third insert outer surface having a catch that engages with the second insert inner surface under torque.

5. The locknut socket of claim 1, wherein the driver sleeve is detachably coupled to the bar.

6. A locknut socket comprising:
a locknut shell having a shell inner surface, the shell inner surface configured to engage with a locknut of a first size;
a bar affixed to the shell inner surface;
and
a first locknut insert having a first insert inner surface and a first insert outer surface, the first insert inner surface configured to engage with a locknut of a second size smaller than the first size,
wherein
the bar is configured to transfer torque to the locknut shell, and
the first insert outer surface comprises a first catch that engages with the shell inner surface under torque.

7. The locknut socket of claim 6, further comprising a driver sleeve coupled to the bar, the driver sleeve having receptacle configured to engage with a lever.

8. The locknut socket of claim 7, wherein the bar is welded to the shell inner surface.

9. The locknut socket of claim 7, wherein the driver sleeve is detachably coupled to the bar.

10. The locknut socket of claim 6, wherein the shell inner surface and the first insert inner surface each comprise a polygonal cross-section having six sides or eight sides.

11. The locknut socket of claim 6, wherein the bar extends along a line that passes through a center point of a cross section of the shell inner surface.

12. A locknut socket set comprising:
a first locknut shell having a first shell inner surface, the first shell inner surface configured to engage with a lockout of a first size, a first bar being affixed to the first shell inner surface;
a second locknut shell having a second shell inner surface, the second shell inner surface configured to engage with a locknut of a second size different from the first size, a second bar being affixed to the second shell inner surface;
a driver sleeve having receptacle configured to engage with a lever;
a first locknut insert having a first insert inner surface and a first insert outer surface, the first insert inner surface configured to engage with a locknut of a third size; and
a second locknut insert having a second insert inner surface and a second insert outer surface, the second insert inner surface configured to engage with a locknut of a fourth size,
wherein
the first bar is configured to detachably couple to the driver sleeve and transfer torque from the driver sleeve to the first locknut shell,
the second bar is configured to detachably couple to the driver sleeve and transfer torque from the driver sleeve to the second locknut shell,
the first insert outer surface comprises a first catch that engages with the first shell inner surface under torque, and
the second insert outer surface comprises a second catch that engages with the second shell inner surface under torque.

13. The locknut socket set of claim 12, further comprising a ratchet lever compatible with the driver sleeve.

14. The locknut socket set of claim 12, wherein the first catch engages with the second shell inner surface under torque.

15. The locknut socket set of claim 14, wherein the second catch engages with the first shell inner surface under torque.

16. The lockout socket set of claim 12, wherein the second catch engages with the first shell inner surface under torque.

17. The locknut socket set of claim 12, further comprising further comprising a third locknut insert having a third insert inner surface and a third insert outer surface, the third insert inner surface configured to engage with a locknut of a fifth size, and the third insert outer surface having a third catch that engages with the first insert inner surface under torque.

18. The locknut socket set of claim 17, wherein the third catch engages with the second insert inner surface under torque.

19. The locknut socket set of claim 12, further comprising further comprising a third locknut insert having a third insert inner surface and a third insert outer surface, the third insert inner surface configured to engage with a locknut of a fifth size, and the third insert outer surface having a third catch that engages with the second insert inner surface under torque.

20. The locknut socket of claim 12, wherein each of the first shell inner surface, the second shell inner surface, the first insert inner surface, and the second insert inner surface have a polygonal cross-section having six sides or eight sides.
